(19) United States
(12) Patent Application Publication
(10) Pub. No.: US 2021/0108442 A1
(43) Pub. Date: Apr. 15, 2021

(54) COMPONENT FOR USE IN A LOCKING DEVICE

(71) Applicant: Henry Squire & Sons Holdings Ltd, Wolverhampton (GB)

(72) Inventors: John Wilkins, Wolverhampton (GB); Glyn Green, Wolverhampton (GB)

(21) Appl. No.: 17/066,731

(22) Filed: Oct. 9, 2020

(30) Foreign Application Priority Data
Oct. 11, 2019 (GB) 1914714.9

(51) Int. Cl. E05B 9/08; E05B 3/06

(52) U.S. Cl. CPC E05B 9/084; E05B 3/065

(57) ABSTRACT

A component for use in a locking device such as a door lock or a padlock or bike lock that uses a shackle is disclosed. The component includes a body and a pair of rotatable plugs which sit within a cylinder of the body. One plug is connected to a handle and the other is connected to a lock release mechanism. A bridge selectively connects and releases the first and second plugs and an actuator, cooperating with biasing devices, is used to determine whether the bridge is in a connecting or releasing condition. This is in turn determines whether the component is acting to operate the lock in a locked or an unlocked condition.

### CROSS-REFERENCE TO RELATED APPLICATIONS

This patent application claims priority from United Kingdom patent application No. 1914714.9, filed on Oct. 11, 2019, the entire disclosure of which is incorporated herein by reference.

### FIELD OF THE INVENTION

The present invention relates to a component for use in a locking device and to a locking device and relates particularly, but not exclusively, to a component for use in a door or shackle type electronic locking device.

### BACKGROUND OF THE INVENTION

The use of keypad controlled or electronically controlled door entry devices is commonplace. Such devices are designed to control access through a door in one direction, whilst always allowing the door to open in the other direction. This allows access into an area to be controlled by the issuing of electronic keys, such as RFID tags, or by knowing a keypad code. At the same time, it is necessary that in the event of an emergency, the door can be easily opened from the inside to allow evacuation. Such keypads typically control the use of a handle with a handle on the inside always able to operate but the handle on the outside blocked by a pin which is retracted upon entry of the correct code or presentation of the correct RFID key. However, this mechanism of preventing turning of a handle can lead to frustration in users, or persons wishing to gain unauthorised entry, resulting in an inclination to attempt to force the handle which can result in damage to the lock. This damage can be prevented by fitting a clutch to the handle which will slip if an access force is applied. However, the calibration of such clutches so that they operate effectively throughout the life of the lock adds significant complication to the manufacture of the locking device.

Combination lock release mechanisms are also used in locks that utilise shackles to perform their function such as padlocks and bike locks. In these locks it is commonplace to have a button, or some other mechanical device, which must be pressed once the dials have been correctly aligned, in order to release the shackle from engagement with the body of the lock. However, in an attempt to overcome the mechanism excess force can be applied to the button resulting in damage to the lock.

Preferred embodiments of the present invention seek to overcome or alleviate the above described disadvantages of the prior art.

### BRIEF SUMMARY OF THE INVENTION

According to an aspect of the present invention there is provided a component for use in a locking device, the component comprises a body and a first plug rotatable within the body. The first plug is for connection to a handle for operation of the locking device and has a first recess formed therein. There is also a second plug rotatable within the body and this second plug is connected to a lock release mechanism which has a second recess formed therein. A bridge connects and releases the first and second plugs and an actuator, working with at least one first biasing device, together control the position of the bridge relative to the first and second recesses. The component operates between an unlocked and a locked condition, so that in the unlocked condition the bridge is located in the first and second recesses, thereby linking the rotation of the first and second plugs. As a result, rotation of the first plug, by rotation of the handle, causes the rotation of the second plug and in turn the lock release mechanism. However, in the locked condition the bridge is located outside the first and second recesses, thereby allowing separate rotation of the first and second plugs.

By providing two plugs which are able to rotate separately and a bridge which joins them together, the advantage is provided that this component can be used to split the spindle of a door handle between an entry control handle and the latch. As a result, the entry control handle only operates the latch when the bridge joins the two plugs whereas a handle on the other side of the door remains always connected to the latch allowing exit under all circumstances. The handle on the keypad side freely rotates without engagement with the latch thereby meaning that this handle cannot be forced, by applying excess force to the handle. The component can be used in other locking situations including, for example, on locks which utilise a shackle such as padlocks and bike locks. In this instance the first plug is connected to a handle and the second plug is connected to a latch for the shackle. When a correct signal is received from a keypad or an electronic key, the bridge connects the two plugs allowing rotation of the handle to free the latch to the shackle thereby opening the lock. The advantage is similarly that applying excess force to the handle cannot force or damage the lock.

In a preferred embodiment the body comprises a cylinder for at least partially containing the plugs.

By using a cylinder to at least partially contain the plugs, the advantage is provided that the component can be formed as a complete unit for insertion into a locking device. Furthermore, the same component can be used in a variety of different locking mechanisms.

In another preferred embodiment the body further comprises a third recess for receiving the bridge when the component is in a locked condition.

By providing the body with a third recess into which the bridge is received when in the locked condition, the advantage is provided that the movement of the bridge is contained between the first and second recesses and the third recess.

In a further preferred embodiment the at least one first biasing device comprises a plurality of first biasing devices with at least one first biasing device associated with each the plug.

By having a plurality of biasing devices, specifically two biasing devices one associated with each plug, the advantage is provided that and evenly distributed force can be applied to the bridge, helping to ensure consistent operation of the bridge and therefore the lock in all circumstances.

In a preferred embodiment the first biasing device comprises a spring.

In another preferred embodiment the first biasing device further comprises a pin to engage the bridge.

In a further preferred embodiment the actuator is a linear actuator, movement of the linear actuator being aligned with a direction of movement of the bridge.

By using pins and springs, the advantage is provided that when the first and second recesses are rotated out of alignment with the third recess, the linear actuator is able to retract, typically after a predetermined period of time. The bridge will be pushed back into the third recess when the recesses are aligned once more.

### BRIEF DESCRIPTION OF THE DRAWINGS

Preferred embodiments of the present invention will now be described, by way of example only, and not in any limitative sense with reference to the accompanying drawings in which:

FIG. 1 is an isometric view of a locking device and including a component of the present invention;

FIG. 2 is an exploded isometric view of a component of a locking device of the present invention; and

FIGS. 3 to 6 are front and side views of the component of FIG. 2 in unlocked and locked conditions.

### DETAILED DESCRIPTION OF THE INVENTION

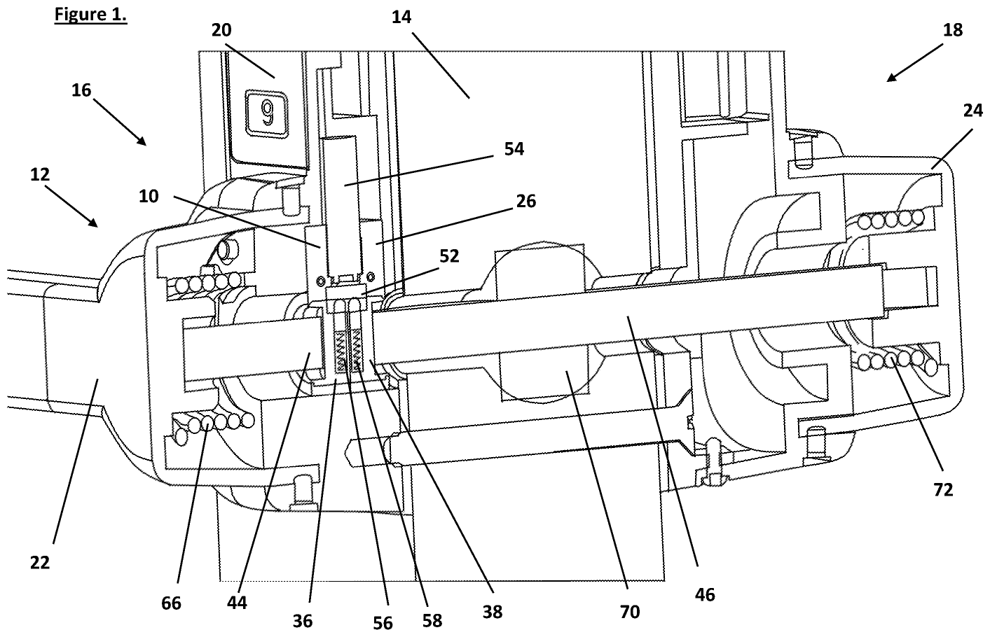

Referring initially to FIG. 1, a component 10 for a locking device 12 is provided to allow and prevent the opening of a door 14. The component 10 can be used in other locking devices and can particularly be used in devices which utilise a shackle such as padlocks and bike locks. The locking device 12 shown in FIG. 1 is of the type used to limit access through the door 14 in one direction, whilst always allowing access in the other direction. This device will be described with reference to an outside 16 and an inside 18 of the door 14. Access from the outside 16 is controlled via a keypad (partially shown at 20) which only allows operation of the lock if the correct code is entered on the keypad. In the event that the correct code is entered to the keypad 20 the outer handle 22 is able to operate the door, whereas, if no code has been entered, or an incorrect code has been entered, rotation of the handle 22 has no effect on the opening of the door. In contrast, the rotation of the handle 24 on the inner side 18 always operates the door latching mechanism to allow the opening of the door. Detail of this operation is set out below, together with discussion of how the shackle type locks operates.

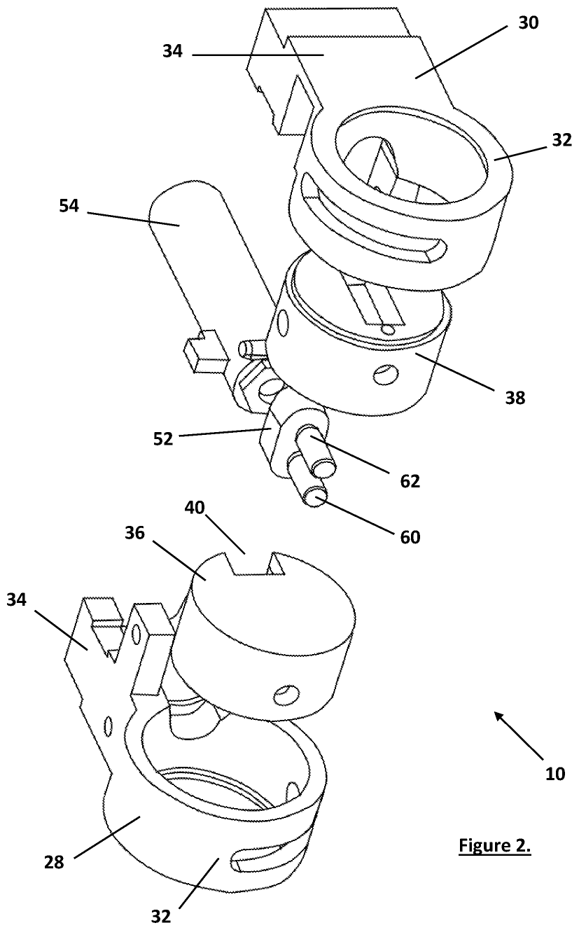

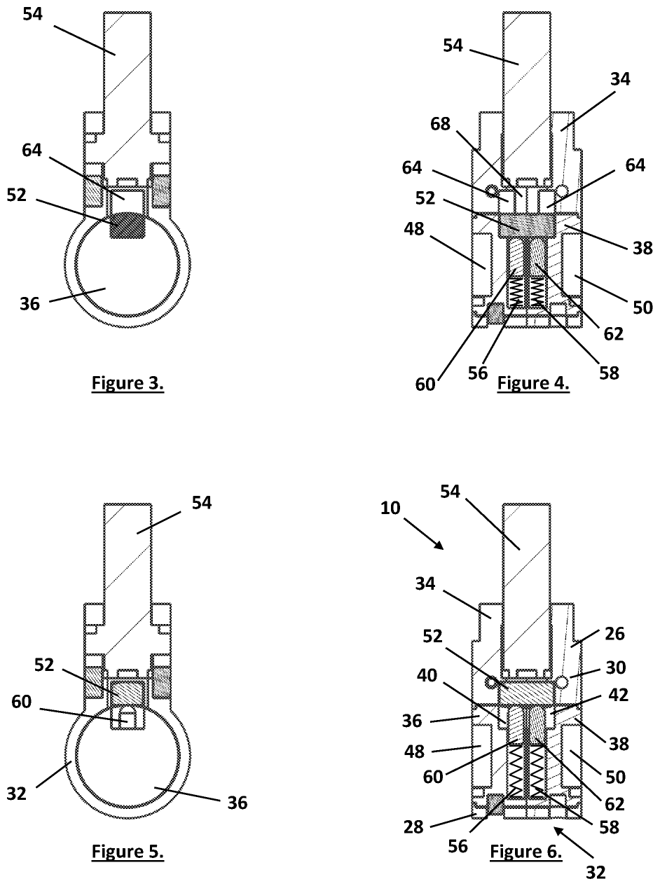

Referring additionally to FIG. 2 and then FIGS. 3 to 6, the component 10 will now be described in more detail. A body 26 is formed from two body halves 28 and 30, which each include an annular cylinder 32 and an extension 34. Contained, in use, at least partially within the cylinder portions 32 of the body halves 28 and 30 are first and second plugs 36 and 38 which are rotatable within their respective portions of the cylinder 32. The first plug 36 has a first recess 40 formed therein and the second plug 38 has a second recess 42 similarly formed therein. When the component 10 is in use, opposing faces of the first and second plugs 36 and 38 are in contact with each other and the first and second recesses 40 and 42 are connected together to form a single opening or recess. In use, the first and second plugs 36 and 38 are connected to the handles 22 and 24 via first and second spindles 44 and 46. As a result, rotation of the outside handle 22 causes rotation of the first spindle 44 and the first plug 36 due to the first spindle 44 extending into a first slot 48 in the first plug 36. Likewise, rotation of the inner handle 24 causes rotation of the second spindle 46 which in turn rotates the second plug 38 due to the second spindle extending into a second slot 50 in the second plug 38. It should be noted that components such as the body halves 28 and 30 and the plugs 36 and 38 are identical components which are designed to fit together to operate in the manner described herein thus reducing the number of different components that must be manufactured.

Also forming part of component 10 is a bridge 52 which is used to connect and release the first and second plugs 36 and 38. The position of the bridge 52 relative to the first and second recesses 40 and 42 in the first and second plugs 36 and 38 is controlled by a combination of an actuator, in the form of a linear actuator 54 and a pair of biasing devices. The linear actuator 54 is preferably of a type that does not directly utilise magnets to achieve the linear movement, but instead uses a small electric motor to extend a shaft using a helical thread. The biasing devices are each formed from a spring (56 in the first plug 36 and 58 in the second plug 38) and a pin (60 in the first plug and 62 in the second plug). A third recess 64 is formed in the extension portion 34 of the body 26 and the bridge 52 is able to move between the third recess and the combined first and second recesses 40 and 42 depending upon the operating condition of the linear actuator 54.

Operation of the component 10 used in door 14 will now be described. In FIGS. 1, 5 and 6, the component 10 in locking device 12 is shown in a locking condition, meaning that the locking device 12 is locked and rotation of the outside handle 22 will not unlock the door 14. This is because the bridge 52 is contained within the third recess 64 and is therefore not connecting the first and second plugs 36 and 38. Rotation of the outside handle 22, in an anticlockwise direction by pushing the handle down, causes the same anticlockwise rotation of the first spindle 44 which in turn causes rotation of the first plug 36. With the bridge 52 contained within the third recess 64, the first plug 36 is able to rotate relative to the second plug 38. As the first plug 36 rotates, the first pin 60 is pushed against the inner surface of the cylinder 32 of the body half 28. The use of a rounded head on the top of the pins facilitates this movement of the pins past the junction of the bridge 52 and the inner surface of the cylinder 32. When the handle 22 and the first plug 36 have rotated, the first recess 40 is no longer aligned with the bridge 52 in the third recess 64 and the bridge is therefore unable to move.

In order to unlock the door from the outer side 16, the correct code must be entered into the keypad 20. When a processor (not shown) has received a signal indicating that the correct code has been entered, a further signal is sent to the linear actuator 54, causing it to extend. Specifically, a shaft 68 extends from the actuator 54 and presses against the bridge 52, causing it to move from the third recess 64 into the combined first and second recesses 40 and 42. As a result, the pins 60 and 62 are pressed against the biasing force of springs 56 and 58 which become compressed, as shown in FIG. 4. With the bridge 52 contained within the first and second recesses 40 and 42, the first and second plugs 36 and 38 are now connected and any rotational movement of one plug causes the rotation of the other. Therefore, if the handle 22 is moved downwards in an anticlockwise direction when the shaft 68 of the linear actuator 54 is extended, the rotation of the first spindle 44 causes the rotation of the first and second plugs 36 and 38. Because the second plug 38 has rotated the second spindle 46 also rotates and this causes the rotation of the latching mechanism of the door 14 (which is partially shown as item 70) and the door 14 can then be opened. It should be noted that in this condition, where the bridge 52 connects the first and second plugs 36 and 38, that rotation of the outside handle 22 also causes rotation of the inside handle 24.

After a predetermined period of time, typically a couple of seconds, the linear actuator 54 retracts the shaft 68. When handle 22 is released a handle return spring 66 causes it to move upwards, rotating in a clockwise direction and returning it, the first spindle 44 and the first plug 36 to their original positions. If the shaft 68 of the linear actuator 53 has retracted then the bridge 52 is able to return into the third recess 64.

An important function of the lock 12 is to ensure that under all circumstances, including the loss of power to the locking device 12, that the door 14 can be opened from the inner side 18 by simple rotation of the handle 24 in a way that is normal, instinctive and in a single action as commonly required by fire safety regulations. Downward movement of the handle 24, causing rotation in a clockwise direction, results in rotation of the second spindle 46, which in turn causes the rotation of the latching mechanism 70, allowing the door 14 to be opened. This rotation of the second spindle 46 causes the rotation of the second plug 38 within the cylinder 32. Because no code has been entered into the keypad 20 the linear actuator 54 is in a retracted condition and the pins 60 and 62 and springs 56 and 58 push the bridge 52 into the third recess 64, the first and second plugs are not connected. As a result, the rotation of the second plug 38 does not cause the rotation of the first plug 36 and the outer handle 22 does not rotate. When the inner handle 24 is released a handle return spring 72, similar to the spring 66, causes the inner handle 22 to rotate anticlockwise and upwards back into the original condition prior to the door being opened.

As previously mentioned, the component 10 can be used in other locking devices including, but not limited to, devices which utilise a shackle as part of the device, such as padlocks and bike locks. In this instance, the lock operates with a single handle (equivalent to outer handle 22) which is typically a rotatable knob. When the component 10 is in the unlocked condition with the bridge 52 contained within the third recess 64, the knob is free to rotate which causes the first plug 36 to rotate within the cylinder 32. Because the bridge is not connecting the first and second plugs 36 and 38 any rotation of this knob has no further impact on the lock. If the correct key has been introduced or code applied, a processor causes the linear actuator 54 to extend which pushes the bridge 52 into the combined first and second recesses 40 and 42. When in this condition rotation of the knob causes rotation of the first and second plugs together due to their connection by the bridge 52. The rotation of the second plug portion 38 causes the retraction of a latch connected to the shackle of the locking device allowing the shackle to be released in a way that is familiar to persons skilled in the art. This mechanism has the benefit that no amount of excess rotational force applied to the knob will cause the padlock or bike lock to become unlocked and this therefore reduces the likelihood of damage being caused to the locked by somebody attempting to force it by applying excess torque to the knob.

It will be appreciated by persons skilled in the art that the above embodiments have been described by way of example only and not in any limitative sense, and that various alterations and modifications are possible without departure from the scope of the protection which is defined by the appended claims. For example, the keypad 20 can be replaced with any other suitable unlocking mechanism which produces a signal, which can be used to in turn cause the linear actuator 54 to extend the shaft 68. Examples include, but are not limited to, electronic keys, RFID keys, Bluetooth® and Near Field Communication (NFC) keys associated with portable devices such as mobile phones and the like.

Other variations on the apparatus include the use of different biasing means for the first and second springs 56 and 58 which could include the use of repelling magnets to replace the springs. In a further alternative version of the biasing device, a magnet is included in the linear actuator 54, in particular, attached to the extending shaft 68 with the bridge 52 being made from a ferromagnetic material. In the example, the bridge 52 is attracted to the shaft 68 generally keeping it in the third recess 64 but allowing it to be separated when in the first and second recesses 40 and 42 and the handle turned. However, such devices could suffer from the disadvantage that they may be overcome by the use of carefully located very powerful magnets to draw the bridge 52 into engagement with the first and second recesses 40 and 42. Furthermore, other actuators could be used to replace the linear actuator 54. Any actuator which is able to move the bridge 52 from the third recess 64 into the combined first and second recesses 40 and 42 would be suitable to fulfil the function, although may not be as secure as the use of the linear actuator previously described.

What is claimed is:

1. A component for use in a locking device, the component comprising:
a body;
a first plug rotatable within said body, said first plug for connection to a handle for operation of the locking device and having a first recess formed therein;
a second plug rotatable within said body, said second plug for connection to a lock release mechanism and having a second recess formed therein;
a bridge for connecting and releasing said first and second plugs; and
an actuator and at least one first biasing device together for controlling the position of said bridge relative to said first and second recesses,
wherein said component operates between an unlocked and a locked condition, in said unlocked condition said bridge is located in said first and second recesses, thereby linking rotation of said first and second plugs such that rotation of said first plug, by rotation of the handle, causes the rotation of said second plug and in turn said lock release mechanism whereas in said locked condition said bridge is located outside said first and second recesses, thereby allowing separate rotation of said first and second plugs.

2. A component according to claim 1, wherein said body comprises a cylinder for at least partially containing said plugs.

3. A component according to claim 1, wherein said body further comprises a third recess for receiving said bridge when said component is in said a locked condition.

4. A component according to claim 1, wherein said at least one first biasing device comprises a plurality of first biasing devices with at least one first biasing device associated with each said plug.

5. A component according to claim 1, wherein said first biasing device comprises a spring.

6. A component according to claim 5, wherein said first biasing device further comprises a pin to engage said bridge.

7. A component according to claim 1, wherein said actuator is a linear actuator, movement of said linear actuator being aligned with a direction of movement of said bridge.

8. A locking device comprising:
a first handle;
a cylinder;
a first plug rotatable within said cylinder, said first plug for connection to a handle for operation of the locking device and having a first recess formed therein;
a second plug rotatable within said cylinder, said second plug for connection to a lock release mechanism and having a second recess formed therein;
a bridge for connecting and releasing said first and second plugs; and
an actuator and at least one first biasing device together for controlling the position of said bridge relative to said first and second recesses,
wherein said component operates between an unlocked and a locked condition, in said unlocked condition said bridge is located in said first and second recesses, thereby linking rotation of said first and second plugs such that rotation of said first plug, by rotation of the handle, causes the rotation of said second plug and in turn said lock release mechanism whereas in said locked condition said bridge is located outside said first and second recesses, thereby allowing separate rotation of said first and second plugs;
an activator; and
a lock release mechanism.

9. A locking device according to claim 8, wherein said activator comprises a signal receiver and a processor connected to said linear actuator.

10. A locking device according to claim 9, wherein said signal receiver comprises one or more of: a keypad; a RFID receiver; and a Bluetooth® receiver.

11. A locking device according to claim 8, wherein said lock release mechanism comprises a door latch.

12. A locking device according to claim 8, wherein said lock release mechanism comprises shackle and latch of a padlock, bike lock and the like.

13. A locking device according to claim 8, further comprising a spring to return said handle to a condition in which said first and second recesses are substantially aligned.

14. A locking device according to claim 8, further comprising a second handle in use in fixed connection to said second plug.

15. A component for use in a locking device, the component comprising:
a cylinder;
a first plug rotatable within said cylinder, said first plug for connection to a handle for operation of the locking device and having a first recess formed therein;
a second plug rotatable within said cylinder, said second plug for connection to a lock release mechanism and having a second recess formed therein;
a bridge for connecting and releasing said first and second plugs; and
a linear actuator and a pair of biasing devices respectively located in the first and second plugs for controlling the position of said bridge relative to said first and second recesses,
wherein said component operates between an unlocked and a locked condition, in said unlocked condition said bridge is located in said first and second recesses, thereby linking rotation of said first and second plugs such that rotation of said first plug, by rotation of the handle, causes the rotation of said second plug and in turn said lock release mechanism whereas in said locked condition said bridge is located in a third recess formed in said cylinder, thereby allowing separate rotation of said first and second plugs.
